(19) United States
(12) Patent Application Publication
(10) Pub. No.: US 2021/0354232 A1
(43) Pub. Date: Nov. 18, 2021

(54) METHODS FOR THE AUTOMATED DETERMINATION OF THE INFLUENCE OF A LASER PROCESSING PARAMETER ON A LASER PROCESSING OPERATION, LASER PROCESSING MACHINE, AND COMPUTER PROGRAM PRODUCT

(71) Applicant: TRUMPF Laser-und Systemtechnik GmbH, Ditzingen (DE)

(72) Inventors: Artur Schellenberg, Neuenburg am Rhein (DE); Johannes Seebach, Stuttgart (DE)

(21) Appl. No.: 17/443,722

(22) Filed: Jul. 27, 2021

Related U.S. Application Data
(63) Continuation of application No. PCT/EP2020/052016, filed on Jan. 28, 2020.

(30) Foreign Application Priority Data
Jan. 28, 2019 (DE) 102019201033.4

(51) Int. Cl. B23K 26/00; B23K 26/38; B23K 26/21; B23K 26/03; B23K 26/14; B23K 37/02

(52) U.S. Cl. CPC B23K 26/0006; B23K 26/38; B23K 26/21; B23K 26/0876; B23K 26/14; B23K 37/0235; B23K 26/03

(57) ABSTRACT

Methods, machines, and computer program products are disclosed for determining the influence of a laser processing parameter on a laser processing operation by means of a laser beam are described. The methods include conducting linear laser processing operations with different values of the laser processing parameter, the speed of advance of the laser beam, respectively, being increased in the laser processing operations at least to such an extent that a processing interruption occurs; and determining a relationship between the processing lengths, the associated processing times, or the associated interruption speeds of the laser processing operations and the laser processing parameter using the measured processing lengths, the associated processing times, or the associated interruption speeds of the laser processing operations.

### CROSS REFERENCE TO RELATED APPLICATIONS

This application is a continuation of and claims priority under 35 U.S.C. § 120 from PCT Application No. PCT/EP2020/052016, filed on Jan. 28, 2020, which claims priority from German Application No. 10 2019 201 033.4, filed on Jan. 28, 2019. The entire contents of each of these priority applications are incorporated herein by reference.

### TECHNICAL FIELD

The disclosure relates to methods for the determination of the influence of a laser processing parameter on a laser processing operation by a laser beam as well as to laser processing machines suitable for carrying out the methods and to computer program products.

### BACKGROUND

When cutting by a laser beam, deterioration of the cutting quality to the extent of a cutting interruption may occur. Causes are usually deviations in the laser beam profile. Consequences are long machine down times and unsatisfied customers. There is currently no possibility of tracing the fault causes by using a machine, but instead the laser processing machine must be stopped so that an employee qualified therefor can take care of the problem. Currently, different methods, which rely on subjective evaluation, are used for adjusting or checking the optical setpoint status of the laser processing machine. Furthermore, expensive measurement means, large time expenditure and special knowhow are required in order to determine, for example, a power-dependent focal shift, a power loss, a focal diameter variation, etc.

### SUMMARY

The present disclosure provides simple and economical methods to determine the influence of a laser processing parameter on the laser processing operation, e.g., in an automated fashion. For example, optimal laser processing parameter values and the cause of laser processing parameter changes can be found in the shortest possible time.

These advantages are achieved by methods for the determination, e.g., for the automated determination, of the influence of a laser processing parameter on a laser processing operation by a laser beam, having the following steps:
(a) conducting, e.g., fully automatically conducting, linear laser processing operations with one or more values, e.g., different values, of the laser processing parameter, wherein the speed of advance of the laser beam is increased in the laser processing operations at least to such an extent that a processing interruption occurs; and
(b) determining, e.g., fully automatically determining, the relationship between the processing lengths, the associated processing times, or the associated interruption speeds of the laser processing operations and the laser processing parameter, with the aid of the measured processing lengths, the associated processing times, or the associated interruption speeds of the laser processing operations.

According to the disclosure, either a sensor unit (for example a photodiode in the laser beam generator or a surface welding depth sensor (OCT)) fully automatically (unmanned) detects, or a human operator detects, a processing interruption caused by the laser processing process as a function of a laser processing parameter. The evaluation is carried out fully automatically (unmanned) by a machine controller of the laser processing machine or by the operator. The laser processing parameter can be a laser beam-related parameter (wavelength, beam quality, intensity distribution, focal position of the laser beam in the beam direction (z focal position), focal diameter of the laser beam, or the laser cable, or the laser power) and/or a gas-dynamic parameter for a predetermined gas composition, which, e.g., is determined by nozzle type, nozzle diameter, distance of the nozzle, and/or the workpiece.

Starting from an initial rate of advance, acceleration is always carried out in the same way, for example continuously or stepwise, to a final rate of advance with the laser beam turned on. The laser-related sensor unit fully automatically and in an unmanned fashion detects the laser processing time between the start of laser processing and an interruption of the respective laser processing. Because of the acceleration always being the same, the laser processing time is representative of the respective laser processing length for the respective value of the laser processing parameter. As an alternative, the machine controller may also establish the speed of advance existing at the time of the interruption as an interruption speed and assign it to the respective value of the laser processing parameter; in this case, the laser processing speed does not always have to be accelerated in the same way, but may be accelerated in any desired way. In the manual variant, the laser processing length is measured by the operator and assigned to the respective value of the laser processing parameter.

In another embodiment, the influence of a cutting parameter on a workpiece processing operation by the laser beam is determined, e.g., determined in an automated fashion, by the following steps:
(a) conducting, e.g., automatically conducting, linear laser cuts on a workpiece with different values of the cutting parameter, wherein the cutting speed respectively is increased in the laser cuts at least to such an extent that a cutting interruption occurs; and
(b) determining, e.g., automatically determining, the relationship between the cutting lengths, the associated cutting times, or the associated interruption speeds of the laser cuts and the cutting parameter with the aid of the measured cutting lengths, the associated cutting times, or the associated interruption speeds of the laser cuts.

In another embodiment, the influence of a welding parameter on a workpiece processing operation by the laser beam is determined, e.g., determined in an automated fashion, by the following steps:
(a) conducting, e.g., automatically conducting, linear laser penetration welds on a workpiece with different values of the welding parameter, wherein the welding speed respectively is increased in the laser penetration welds at least to such an extent that a penetration welding interruption, e.g., a transition to surface welding, occurs; and
(b) determining, e.g., automatically determining, of the relationship between the penetration welding lengths, the associated welding times or the associated interruption speeds of the laser penetration welds, and the welding parameter with the aid of the measured penetration welding lengths, the associated welding times, or the associated interruption speeds of the laser penetration welds.

Variations in the laser beam, for example because of contamination of the optics, may be identified by the propagation distance in the machine, and detrimental effects on the welding outcome may be prevented or reduced promptly. By contamination of the welding optics (e.g., by splashes), a part of the laser power is absorbed by the optical components and is absent from the process on the workpiece. The penetration welding threshold is correspondingly reached earlier (since a part of the energy is missing), and the penetration welding distance is correspondingly shortened. This may be detected by the proposed methods. To diagnose the laser beam properties by the welding process in laser beam welding, the so-called penetration welding threshold is used. This is the transition from the surface welding process to the penetration welding process, or vice versa. At the penetration welding threshold, the radiation energy is thus just sufficient to melt the material over the entire sheet-metal thickness. The speed is increased continuously, with otherwise constant parameterization. Initially, penetration welding of the sheet metal takes place with a power excess. If the speed increases further, the aforementioned penetration welding threshold is reached, which is used here as a criterion for the evaluation. With a further increase of the rate of advance, the energy is not sufficient for penetration welding, so that surface welding or an interruption of the penetration welding takes place thereafter. If, for example, the focal position is then varied in the next step, the rate of advance of the penetration welding threshold changes and occurs earlier if the weld seam is wider, or later if the weld seam width is less. By means of the variation of the focal positions, the longest distance on the lower side of the sheet metal may either be measured manually or detected automatically by a sensor unit (for example a surface welding depth sensor (OCT) or a diode internal to the laser instrument). In this way, it is possible to check laser-related properties and reflect them in the condition monitoring of the machine, and to recommend handling recommendations if a threshold is violated.

In other embodiments, the influence of a fusion parameter during the fusion of metal powder by the laser beam is determined, e.g., determined in an automated fashion, by the following steps:
(a) producing, e.g., automatically producing, linear melting tracks with different values of the fusion parameter, wherein the speed of advance of the laser beam respectively is increased in the melting tracks at least to such an extent that a melting track interruption occurs; and
(b) determining, e.g., automatically determining, the relationship between the melting track lengths, the associated fusion times, or the associated interruption speeds of the melting tracks, and the fusion parameter with the aid of the measured melting track lengths, the associated fusion times, or the associated interruption speeds of the melting tracks.

Changes of the optical setup with process powder input in the LMD (Laser Metal Deposition) process, for example because of contamination of the optics, may be identified by the propagation distance in the machine, and detrimental effects on the fusion outcome may be prevented or reduced promptly. By linear variation of one manipulated variable with stepwise variation of a further manipulated variable, the longest fusion track that occurs for a given energy input by interaction with the powder, or a powder jet, can be determined. The longest melting track is evaluated in an automated fashion by laser-related sensors of the machine. The energy of the laser beam is converted with different efficiencies for the melting and fusion of metal powder as a function of the laser beam waist position. The interaction length between the laser beam and the powder, which leads to a particular fusion rate, is to be regarded as an effect variable. The fusion rate may be used for process diagnosis to carry out an assessment of the machine status in a horizontal, tilted, or vertical arrangement of the LMD process.

If, for a given interaction length, the speed of advance increases and a limit speed is reached beyond which the fusion no longer takes place sufficiently because of an energy input that is too low, the interaction length is too short, and no binding of the liquefied powder to the workpiece surface takes place. The maximum melting track length is therefore set up at the limit speed. Above this limit speed, the powder absorbs the laser radiation but no longer binds to the carrier material. The determination of the melting track lengths is carried out for example by evaluating the process-related scattered light, a variation of the emission taking place when the melt binds to the carrier substance. The time from the instant of the start of the process to the signal change may be determined and the limit speed or interruption speed may therefore be calculated. The determination of the maximum melting track length may also be carried out by triangulation- or OCT-based methods.

The methods are suitable both for CW operation and for pulsed operation, so long as the energy is sufficient to separate and melt or fuse the material.

In some embodiments, the laser beam is turned off when reaching the processing interruption, for example, by a laser-related sensor unit in the beam source or by a sensor unit outside the beam source.

In another embodiment, that parameter value for which the processing length, or the associated processing time, or the associated interruption speed of the laser processing operations is maximal is determined, e.g., determined in an automated fashion, as the optimal parameter value. In this case, the optimal parameter value may be determined by interpolation of the measured processing lengths, of the measured processing times, or of the interruption speeds established. In the fully automatic case, the machine may then adjust itself to this optimal parameter value. The optimal parameter values deviate from one another so little in different laser processing machines that subjective evaluation is inapplicable.

If the optimal parameter value to be determined is an optimal z focal position of the laser beam, the laser processing operations are carried out with different z focal positions of the laser beam in step (a). When the optimal z focal position of the laser beam has respectively been determined for different laser powers, a power-dependent focal shift may be determined therefrom.

If the optimal parameter value to be determined is an optimal focal diameter of the laser beam, the laser processing operations are carried out with different focal diameters of the laser beam in step (a).

To be able to establish a power loss occurring in the course of time or a beam expansion occurring in the course of time, with a nominally equal laser power and nominally equal focal diameter, steps (a) and (b) are carried out, e.g., carried out in an automated fashion, for different values of the laser processing parameter “z focal position” at two different instants. The two relationships (curves) respectively determined in this case between the processing lengths of the laser processing operations, the associated processing times, or the interruption speeds of the laser processing parameter “z focal position” are compared with one another so as to establish a power loss or a beam expansion. In the case of a power loss, there is a decrease (negative offset) of the respective processing lengths, processing times or interruption speeds over the entire value range of the laser processing parameter “z focal position” for the subsequently determined curve. In the case of a beam expansion, on the other hand, the two curves respectively intersect at a high focal position and a low focal position, and the subsequently recorded curve has a negative offset in the region between the two points of intersection and respectively a positive offset outside this region.

In another aspect, the present disclosure also relates to laser processing machines having a laser beam generator for generating a laser beam, having a laser processing head, from which the laser beam emerges, and a workpiece base or powder base, both of which are movable relative to one another, and having a machine controller that is programmed to increase the speed of advance in the laser processing operations of a workpiece at least to such an extent that a processing interruption occurs.

In one embodiment, the laser processing machine comprises an interruption detector for detecting a processing interruption and a data memory in which the processing length, the processing time, or the interruption speed, as well as the associated value of the laser processing parameter, are stored while being assigned to one another.

In another embodiment, the machine controller is programmed to determine the relationship between the processing lengths, the associated processing times, or the associated interruption speeds and the laser processing parameter in an automated fashion with the aid of the stored data, and to compare with one another and evaluate, in an automated fashion, a plurality of relationships that have been determined.

In another aspect, the disclosure relates to computer program products, e.g., computer readable media, including one or more computer programs configured to carry out all steps of the methods described herein, when the computer programs are run on a machine controller of a laser processing machine.

### DESCRIPTION OF DRAWINGS

Further advantages and advantageous configurations of the subject matter of the invention may be found in the description, the claims, and the drawing. Likewise, the features referred to above and those yet to be mentioned below may respectively be used independently or jointly in any desired combinations. The embodiments shown and described are not to be understood as an exhaustive list, but rather have an exemplary nature for the presentation of the invention. In the drawings:

FIG. 1 is a schematic that shows a laser processing machine suitable for carrying out the methods disclosed herein.

FIG. 2 is a schematic illustration of a workpiece showing the cutting lengths of laser cuts, respectively, carried out up to the cutting interruption speed for different values of a cutting parameter.

FIG. 3 is a graph that shows the relationship between the cutting lengths/cutting times/cutting interruption speeds of laser cuts, respectively, carried out up to the cutting interruption speed and the cutting parameter “z focal position of the laser beam.”

FIG. 4 is a graph that shows the relationship between the cutting lengths/cutting times/cutting interruption speeds of laser cuts respectively carried out up to the cutting interruption speed and the cutting parameter “z focal position of the laser beam”, respectively for two different laser powers for the case of a focal shift.

FIG. 5 is a graph that shows the relationship between the cutting lengths/cutting times/cutting interruption speeds of laser cuts respectively carried out up to the cutting interruption speed and the cutting parameter “z focal position of the laser beam”, respectively for different laser powers.

FIG. 6 is a graph that shows the relationship between the cutting lengths/cutting times/cutting interruption speeds of laser cuts respectively carried out up to the cutting interruption speed and the cutting parameter “z focal position of the laser beam”, respectively for different focal diameters.

FIG. 7 is a schematic illustration of a workpiece that shows the penetration welding lengths of laser penetration welds respectively carried out up to the interruption speed for different values of a welding parameter.

FIG. 8 is a graph that shows the relationship between the penetration welding lengths/welding times/interruption speeds of laser penetration welds respectively carried out up to the interruption speed and the welding parameter “z focal position of the laser beam.”

FIG. 9 is a schematic illustration of a workpiece that shows the melting track lengths of melting tracks respectively produced up to the interruption speed for different values of a fusion parameter.

FIG. 10 is a graph that shows the relationship between the melting track lengths/fusion times/interruption speeds of melting tracks respectively produced up to the interruption speed and the fusion parameter “z focal position of the laser beam.”

### DETAILED DESCRIPTION

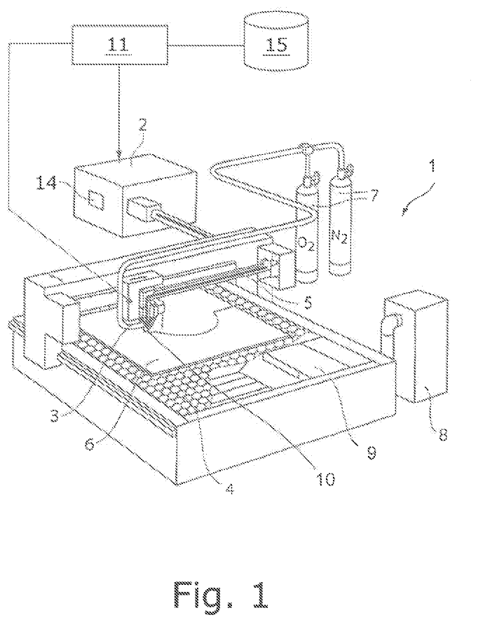

The laser processing machine 1 represented in perspective in FIG. 1 comprises for example a CO₂ laser, diode laser or solid-state laser as a laser beam generator 2, a (laser) processing head 3 displaceable in the X and Y directions, and a workpiece base or powder base 4 configured in this case as a workpiece base. A laser beam 5 (CW or pulsed operation) is generated in the laser beam generator 2 and is guided by a light-guide cable (not shown) or deflecting mirrors (not shown) from the laser beam generator 2 to the processing head 3. A plate-shaped workpiece 6 is arranged on the workpiece base 4. The laser beam 5 is directed onto the workpiece 6 by means of focusing optics arranged in the processing head 3. The laser cutting machine 1 is furthermore supplied with cutting gases 7, for example oxygen and nitrogen, and for an LMD process with helium or argon. The use of the respective cutting gas 7 is dependent on the workpiece material and on quality requirements for the cutting edges. Furthermore provided is a suction device 8, which is connected to a suction channel 9 that is located below the workpiece base 4. The cutting gas 7 is delivered to a cutting gas nozzle 10 of the processing head 3, from which it emerges together with the laser beam 5. The laser processing machine 1 furthermore comprises a machine controller 11.

With the energy of the laser beam 5, a particular melt volume, or a particular melting rate, may be produced in the workpiece 6. If the energy of the laser beam 5 is increasingly deposited transversely with respect to the direction of advance of the laser beam 5 during the laser cutting, for example because of a larger focal diameter or beam diameter on the workpiece 6, the maximum possible cutting speed decreases. FIG. 1 also shows an interruption detector 14, e.g., a photodiode in the laser beam generator 2 arranged to detect a cutting interruption and switches off the laser beam 5, and data memory 15.

To determine the influence of a cutting parameter, for example, the cutting parameter “z focal position F of the laser beam 5,” during the laser cutting of the workpiece 6, the following procedure is adopted:

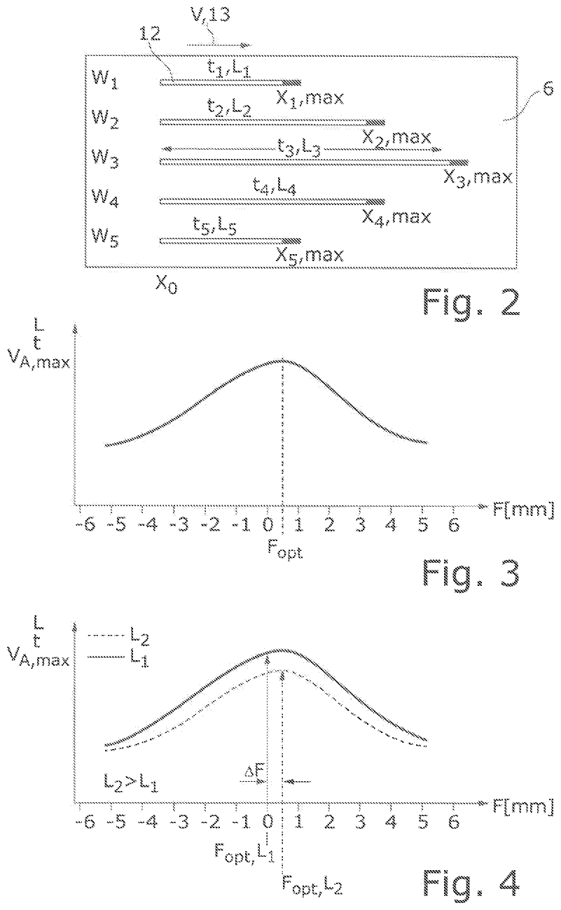

As shown in FIG. 2, a plurality of laser cuts 12 are carried out on the workpiece 6 in the direction of advance 13 at the start point x₀—while being controlled in a fully automated fashion by the machine controller 11—specifically in this case for five different values W₁ to W₅ of the cutting parameter. In this case, during the laser cuts 12, the cutting speed v of the laser beam 5 is respectively increased at least to such an extent that a cutting interruption respectively occurs at the end points x_{1,max} to x_{5,max}. An interruption detector 14, for example, a photodiode in the laser beam generator 2, detects the cutting interruption and turns the laser beam 5 off.

Subsequently—while being controlled in a fully automated fashion by the machine controller 11—the relationship between the cutting lengths L of the laser cuts 12, the associated cutting times t or the associated cutting interruption speeds v_{A} and the cutting parameter is determined with the aid of the measured cutting lengths L₁ to L₅, the associated cutting times t₁ to t₅ or the associated cutting interruption speeds v_{A,1} to v_{A,5} of the laser cuts 12.

By the variation of the z focal position, different amounts of energy are deposited transversely with respect to the direction of advance, which leads to different cutting interruption speeds, i.e., the laser cuts 12 or the cutting times t are of different length. The cutting times t between the start of cutting and the cutting interruption are detected with the aid of the interruption detector 14. As an alternative, the cutting speed existing at the instant of the cutting interruption may be established by the machine controller 11 as a cutting interruption speed v_{A} and assigned to the respective value of the cutting parameter.

FIG. 3 represents the interpolated relationship between the cutting lengths L/cutting times t/cutting interruption speeds v_{A} of laser cuts 12 respectively carried out up to the cutting interruption speed and the cutting parameter “z focal position F of the laser beam 5”. The manipulated variable is thus the z focal position F of the laser beam 5. This is varied and a laser cut 12 is carried out with a continuous acceleration up to the cutting interruption. The z focal position is then varied, the machine axis travels to the next position, and the laser cut 12 is repeated on the workpiece 6 with the same continuous acceleration up to the cutting interruption. That z focal position of the laser beam 5 for which the cutting length L, or the associated cutting time t, or the associated cutting interruption speed v_{A} of the laser cuts 12 is maximal is determined by the machine controller 11 in an automated fashion as the optimal focal position Fₒₚₜ, and the machine controller 11 adjusts the focal position of the laser beam 5 automatically to this optimal focal position Fₒₚₜ.

If, as shown in FIG. 4, the relationship between the cutting lengths L/cutting times t/cutting interruption speeds v_{A} of laser cuts 12 and the z focal position F is respectively recorded for two different laser powers L₁ and L₂ (L₁>L₂) and the respective optimal focal positions F_{opt,L1} and F_{opt,L2} are determined, a power-dependent focal shift ΔF=F_{opt,L1}−F_{opt,L2} may be determined therefrom.

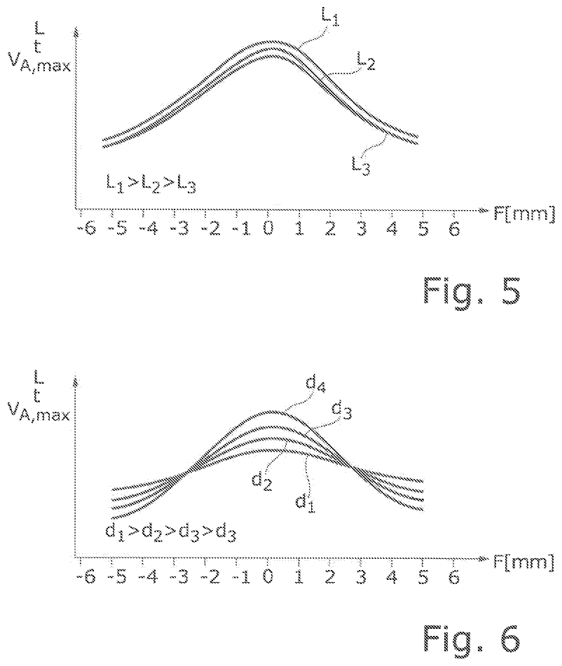

FIG. 5 shows the relationship between the cutting lengths L/cutting times t/cutting interruption speeds v_{A} of laser cuts 12 as a function of the z focal position F of the laser beam 5, respectively for different laser powers L₁, L₂, L₃ (L₁>L₂>L₃). With a lower power, there is a decrease (negative offset) of the respective cutting lengths, cutting times or cutting interruption speeds over the entire value range of the z focal position F in relation to the cutting lengths, cutting times or cutting interruption speeds at a higher power.

FIG. 6 shows the relationship between the cutting lengths L/cutting times t/cutting interruption speeds v_{A} of laser cuts 12 as a function of the z focal position F of the laser beam 5, respectively for different focal diameters d₁, d₂, d₃, d₄ (d₁>d₂>d₃>d₄) of the laser beam 5. The individual curves respectively intersect at a high focal position and a low focal position. In comparison with a larger focal diameter, the cutting lengths, cutting times, or cutting interruption speeds for a smaller focal diameter have a negative offset in the region between the two points of intersection and a positive offset outside this region.

To be able to establish a power loss occurring in the course of time or a beam expansion occurring in the course of time, with a nominally equal laser power and nominally equal focal diameter, the relationships between the cutting lengths L/cutting times t/cutting interruption speeds v_{A} and the z focal position F of the laser beam 5 are determined at two different instants. The curves determined are compared with one another to establish either a power loss or a beam expansion with the aid of the different curve profiles of FIGS. 5 and 6.

The machine implementation may, for example, be carried out as follows:
1. The actual status of the respective laser processing machine 1 is determined by detecting the cutting length L/cutting time Δt/cutting interruption speed v_{A} as a function of the z focal position F.
2. The values determined are stored as a reference in a data memory 15 of the machine controller 11.
3. The machine controller 11 checks the current values with the stored values independently, unmanned, and fully automatically at the arbitrary instant freely defined by the customer.
4. The machine controller 11 evaluates the results based on the interpolated relationship between the cutting lengths L/cutting times Δt/cutting interruption speeds v_{A} of laser cuts, respectively, carried out up to the cutting interruption speed and the cutting parameter z focal position F of the laser beam, e.g., as shown in FIG. 3.
5. Depending on the requirement and possibility, a restricted readjustment (laser power, focal position, etc.) is carried out with advice or a handling recommendation.
6. After the defined limits are exceeded, warning advice is overlaid or servicing intervention is recommended.
7. The machine status is displayed in a traffic light function.

As a result, the described method makes it possible to collect digitized data by means of a cutting pattern, whereupon the laser processing machine 1 adjusts itself independently where possible.

In order to determine the influence of a welding parameter, for example the welding parameter “z focal position F of the laser beam 5”, during the laser welding of the workpiece 6, the following procedure is adopted:

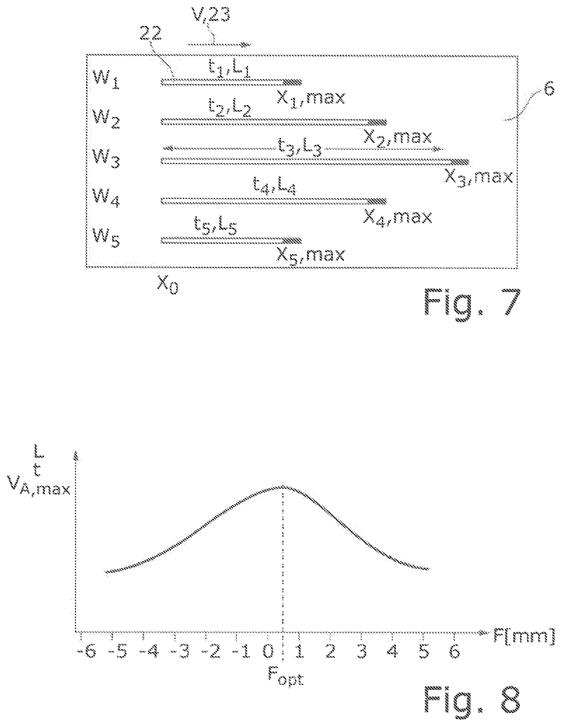

As shown in FIG. 7, a plurality of laser penetration welds 22 are carried out on the workpiece 6 in the direction of advance 23 at the start point x₀—while being controlled in a fully automated fashion by the machine controller 11—specifically in this case for five different values W₁ to W₅ of the welding parameter. In this case, during the laser penetration welds 22, the welding speed v of the laser beam 5 is respectively increased at least to such an extent that a penetration welding interruption respectively occurs at the end points x_{1,max} to x_{5,max}. The interruption detector 14 detects the penetration welding interruption and turns the laser beam 5 off.

Subsequently—while being controlled in a fully automated fashion by the machine controller 11—the relationship between the penetration welding lengths L of the laser penetration welds 22, the associated welding times t or the associated penetration welding interruption speeds v_{A} and the welding parameter is determined with the aid of the measured penetration welding lengths L₁ to L₅, the associated welding times t₁ to t₅ or the associated penetration welding interruption speeds v_{A,1} to v_{A,5} of the laser penetration welds 22.

FIG. 8 represents the interpolated relationship between the penetration welding lengths L/welding times t/penetration welding interruption speeds v_{A} of laser penetration welds 22 respectively carried out up to the penetration welding interruption speed and the welding parameter “z focal position F of the laser beam 5”. That z focal position of the laser beam 5 for which the penetration welding length L, or the associated welding time t, or the associated penetration welding interruption speed v_{A} of the laser penetration welds 22 is maximal is determined by the machine controller 11 in an automated fashion as the optimal focal position Fₒₚₜ, and the machine controller 11 adjusts the focal position of the laser beam 5 automatically to this optimal focal position Fₒₚₜ. The determination of the focal position may be carried out once with a low laser power and once with a high laser power. The difference of the two focal positions corresponds to the power-dependent focal shift.

To determine the influence of a fusion parameter in the LMD process, for example the fusion parameter “z focal position F of the laser beam 5,” during the fusion of metal powder by the laser beam 5, the following procedure is adopted:

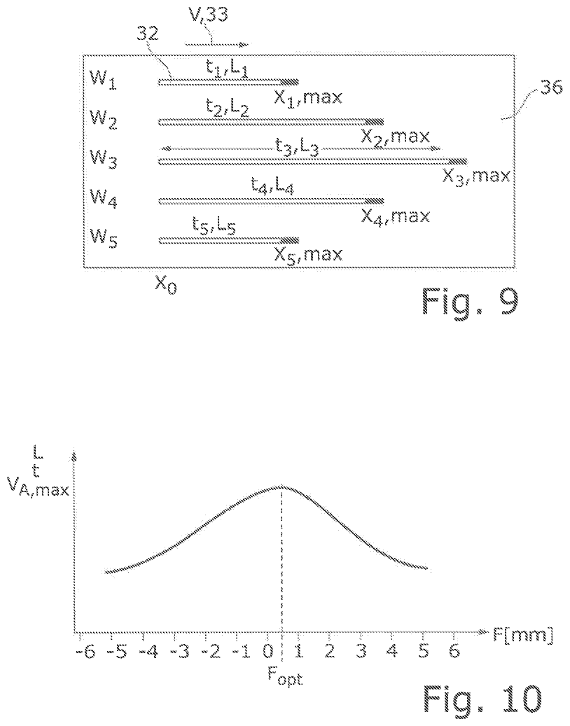

As shown in FIG. 9, a plurality of melting tracks 32 are carried out in a powder bed 36 of the powder base 4 (as an alternative, a powder jet is also possible) in the direction of advance 33 at the start point x₀—while being controlled in a fully automated fashion by the machine controller 11—specifically in this case for five different values W₁ to W₅ of the fusion parameter. In this case, during the melting tracks 32, the cutting speed v of the laser beam 5 is respectively increased at least to such an extent that a melting track interruption respectively occurs at the end points x_{1,max} to x_{5,max}. The interruption detector 14 detects the melting track interruption and turns the laser beam 5 off.

Subsequently—while being controlled in a fully automated fashion by the machine controller 11—the relationship between the melting track lengths L of the melting tracks 32, the associated fusion times t or the associated melting track interruption speeds v_{A} and the fusion parameter is determined with the aid of the measured melting track lengths L₁ to L₅, the associated fusion times t₁ to t₅ or the associated melting track interruption speeds v_{A,1} to v_{A,5} of the melting tracks 32.

FIG. 10 represents the interpolated relationship between the melting track lengths L/fusion times t/melting track interruption speeds v_{A} of melting tracks 32 respectively carried out up to the melting track interruption speed and the fusion parameter “z focal position F of the laser beam 5”. That z focal position of the laser beam 5 for which the melting track length L, or the associated fusion time t, or the associated melting track interruption speed v_{A} of the melting tracks 32 is maximal is determined by the machine controller 11 in an automated fashion as the optimal focal position Fₒₚₜ, and the machine controller 11 adjusts the focal position of the laser beam 5 automatically to this optimal focal position Fₒₚₜ. The determination of the focal position may be carried out once with a low laser power and once with a high laser power. The difference of the two focal positions corresponds to the power-dependent focal shift.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for determining an influence of a laser processing parameter on a laser processing operation by a laser beam, the method comprising:
conducting linear laser processing operations with one or more values of the laser processing parameter being increased in the laser processing operations at least to such an extent that a processing interruption occurs; and
determining a relationship between processing lengths, associated processing times, or associated interruption speeds of the laser processing operations and the laser processing parameter using any one or more of the processing lengths, the associated processing times, or the associated interruption speeds of the laser processing operations.

2. The method of claim 1, wherein the method is automated.

3. The method of claim 1, wherein the laser processing parameter is a speed of advance of the laser beam.

4. The method of claim 1, wherein an influence of a cutting parameter on a workpiece processing operation by the laser beam is determined, the method comprising:
conducting linear laser cuts on a workpiece with different values of the cutting parameter, wherein a cutting speed, respectively, is increased in the laser cuts at least to such an extent that a cutting interruption occurs; and
determining a relationship between cutting lengths, associated cutting times, or associated cutting interruption speeds of the laser cuts and the cutting parameter using any one or more of the cutting lengths, the associated cutting times, or the associated cutting interruption speeds of the laser cuts.

5. The method of claim 1, wherein an influence of a welding parameter on a workpiece processing operation by the laser beam is determined, the method comprising:
conducting linear laser penetration welds on a workpiece with different values of the welding parameter, wherein a welding speed, respectively, is increased in the laser penetration welds at least to such an extent that a penetration welding interruption occurs; and
determining a relationship between penetration welding lengths, associated welding times, or associated penetration welding interruption speeds of the laser penetration welds and the welding parameter using one or more of the penetration welding lengths, the associated welding times, or the associated penetration welding interruption speeds of the laser penetration welds.

6. The method of claim 1, wherein an influence of a fusion parameter during a fusion of metal powder by the laser beam is determined, the method comprising:
producing linear melting tracks with different values of the fusion parameter, wherein a speed of advance of the laser beam, respectively, is increased in the melting tracks at least to such an extent that a melting track interruption occurs; and
determining a relationship between melting track lengths, associated fusion times, or associated melting track interruption speeds of the melting tracks and the fusion parameter using one or more of the measured melting track lengths, the associated fusion times, or the associated melting track interruption speeds of the melting tracks.

7. The method of claim 1,
wherein the laser processing parameter is a laser beam-related parameter, wherein the laser beam-related parameter is at least one of wavelength, beam quality, intensity distribution, focal position in the beam direction (z), focal diameter, or laser power, and/or
wherein the laser processing parameter is a gas-dynamic parameter for a predetermined gas composition determined by nozzle type, nozzle diameter, distance of the nozzle and the workpiece.

8. The method of claim 3, wherein the speed of advance is increased stepwise or continuously.

9. The method of claim 1, wherein the laser beam is turned off when reaching the processing interruption.

10. The method of claim 1, wherein the parameter value for which the processing length, or the associated processing time, or the associated interruption speed of the laser processing operations is maximal is determined as the optimal parameter value.

11. The method of claim 10, wherein the optimal parameter value is determined by interpolation of the processing lengths of the laser processing operations, of the associated processing times, or of the interruption speeds.

12. The method of claim 10, wherein the optimal parameter value is an optimal focal position of the laser beam in the beam direction, and wherein the laser processing operations are carried out with different focal positions of the laser beam in the beam direction.

13. The method of claim 12, wherein the optimal focal position of the laser beam in the beam direction is respectively determined for different laser powers, and wherein a power-dependent focal shift is determined therefrom.

14. The method of claim 10, wherein the optimal parameter value to be determined is a focal diameter of the laser beam, and wherein the laser processing operations are carried out with different focal diameters of the laser beam.

15. The method of claim 10, wherein with a nominally equal laser power and nominally equal focal diameter, the method is carried out for different values of the laser processing parameter focal position of the laser beam in the beam direction at two different instances in time, and wherein either a variation of the laser power impinging on a processing plane or a variation of the focal diameter in the processing plane of the laser beam is established by comparison of the respectively determined relationships between the processing lengths, the associated processing times, or the associated interruption speeds of the laser processing operations and the laser processing parameter focal position of the laser beam in the beam direction.

16. A laser processing machine comprising
a laser beam generator that produces a laser beam;
a laser processing head, from which the laser beam emerges;
a workpiece base or powder base, both of which are movable relative to one another; and
a machine controller programmed to increase a speed of advance of the laser beam in the laser processing operations at least to such an extent that a processing interruption occurs.

17. The laser processing machine of claim 16, further comprising an interruption detector for detecting a processing interruption.

18. The laser processing machine of claim 16, further comprising a data memory in which a processing length, a processing time, or an interruption speed, as well as an associated value of a laser processing parameter, are stored as stored data.

19. The laser processing machine of claim 18, wherein the machine controller is programmed to determine a relationship between the processing length, the associated processing time, or the associated interruption speed and the laser processing parameter in an automated fashion using the stored data.

20. A computer program product comprising a computer readable media including one or more computer programs configured to carry out all steps of the method of claim 1 when the computer programs run on a machine controller of a laser processing machine.
